(19) United States
(12) Patent Application Publication
(10) Pub. No.: US 2024/0310006 A1
(43) Pub. Date: Sep. 19, 2024

(54) METHODS AND SYSTEMS FOR SUPERVISING SAFETY VENTILATION OF UNDERGROUND GAS PIPELINE CORRIDORS BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/670,686

(22) Filed: May 21, 2024

(30) Foreign Application Priority Data
Apr. 23, 2024 (CN) 202410491282.3

(51) Int. Cl. F17D 5/00; E21F 1/00

(52) U.S. Cl. CPC F17D 5/005; E21F 1/00

(57) ABSTRACT

A method and a system for supervising safety ventilation of an underground gas pipeline corridor based on Internet of Things (IoT) are provided. The method is executed by a gas company management platform. The method includes obtaining environmental data of a pipeline corridor segment of the underground gas pipeline corridor from a gas equipment object platform via a gas company sensing network platform, and obtaining pipeline corridor data of the underground gas pipeline corridor from a government supervision comprehensive database via a smart gas government safety supervision sensing network platform, wherein the pipeline corridor data include at least one of ventilation data, structural data, and distribution sequence data; determining a corrosion reaction degree of the pipeline corridor segment based on the environmental data and the pipeline corridor data; and adjusting a ventilation intensity of the pipeline corridor segment in response to the corrosion reaction degree meeting a predetermined adjustment condition.

### CROSS-REFERENCE TO RELATED APPLICATIONS

This application claims priority to Chinese Application No. 202410491282.3, filed on Apr. 23, 2024, the entire contents of which are incorporated herein by reference.

### TECHNICAL FIELD

The present disclosure relates to the field of gas safety, and in particular, to methods and systems for supervising safety ventilation of underground gas pipeline corridors based on Internet of Things (IoT).

### BACKGROUND

Natural ventilation combined with mechanical ventilation is generally used in underground gas pipeline corridors to ensure ventilation inside the pipeline corridor. Due to the different burial depths, temperature, humidity, etc., in different locations of the pipeline corridor, the situation of gas accumulation varies. Uniformly adjusting the ventilation of the underground gas pipeline corridor may lead to issues such as increased operating costs, increased maintenance difficulty, etc.

Therefore, it is desired to provide a method and a system for supervising safety ventilation of an underground gas pipeline corridor based on Internet of Things (IoT), which is capable of controlling the ventilation according to the actual situation inside the underground gas pipeline corridor and ensuring safe and reliable operation of the gas pipeline.

### SUMMARY

One or more embodiments of the present disclosure provide a method for supervising safety ventilation of an underground gas pipeline corridor based on Internet of Things (IoT). The method is executed by a gas company management platform of a system for supervising safety ventilation of an underground gas pipeline corridor based on IoT. The method includes obtaining environmental data of a pipeline corridor segment of the underground gas pipeline corridor from a gas equipment object platform via a gas company sensing network platform, and obtaining pipeline corridor data of the underground gas pipeline corridor from a government supervision comprehensive database via a smart gas government safety supervision sensing network platform, wherein the pipeline corridor data include at least one of ventilation data, structural data, and distribution sequence data; determining a corrosion reaction degree of the pipeline corridor segment based on the environmental data and the pipeline corridor data; and adjusting a ventilation intensity of the pipeline corridor segment in response to the corrosion reaction degree meeting a predetermined adjustment condition.

One or more embodiments of the present disclosure provide a system for supervising safety ventilation of an underground gas pipeline corridor based on Internet of Things (IoT). The system includes a smart gas government safety supervision service platform, a smart gas government safety supervision management platform, a smart gas government safety supervision sensing network platform, a smart gas government safety supervision object platform, a gas company sensing network platform, and a gas equipment object platform. The smart gas government safety supervision service platform is configured to interact with the smart gas government safety supervision management platform. The smart gas government safety supervision management platform includes a government supervision comprehensive database. The smart gas government safety supervision object platform includes a gas company management platform. The smart gas government safety supervision sensing network platform is configured to interact with the smart gas government safety supervision management platform and the gas company management platform. The gas company sensing network platform is configured to interact with the gas equipment object platform and the gas company management platform. The gas company management platform is configured to obtain environmental data of a pipeline corridor segment of an underground gas pipeline corridor from a gas equipment object platform via the gas company sensing network platform and obtain pipeline corridor data of the underground gas pipeline corridor from the government supervision comprehensive database via the smart gas government safety supervision sensing network platform. The pipeline corridor data includes at least one of ventilation data, structural data, and distribution sequence data. The gas company management platform is also configured to determine a corrosion reaction degree of the pipeline corridor segment based on the environmental data and the pipeline corridor data and transmit the corrosion reaction degree to the smart gas government safety supervision management platform via the smart gas government safety supervision sensing network platform; adjust a ventilation intensity of the pipeline corridor segment in response to the corrosion reaction degree meeting a predetermined adjustment condition and transmit an instruction for adjusting the ventilation intensity to the gas equipment object platform via the gas company sensing network platform.

One or more embodiments of the present disclosure provide a non-transitory computer-readable storage medium storing computer instructions. When reading the computer instructions in the storage medium, a computer implements the method described in the above embodiments.

### BRIEF DESCRIPTION OF THE DRAWINGS

The present disclosure is further illustrated in terms of exemplary embodiments. These exemplary embodiments are described in detail with reference to according to the drawings. These embodiments are non-limiting exemplary embodiments, in which like reference numerals represent similar structures, and wherein:

FIG. 1 is a diagram illustrating an exemplary platform structure of a system for supervising safety ventilation of an underground gas pipeline corridor based on Internet of Things (IoT) according to some embodiments of the present disclosure;

FIG. 2 is an exemplary flowchart illustrating a method for supervising safety ventilation of an underground gas pipeline corridor based on Internet of Things (IoT) according to some embodiments of the present disclosure;

FIG. 3 is a schematic diagram illustrating an exemplary corrosion reaction model according to some embodiments of the present disclosure; and

FIG. 4 is a schematic diagram illustrating an exemplary process of determining an adjusted duration according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

Unless the context clearly dictates otherwise, the words “a”, “an”, “one” and/or “the” are not intended to be specific in the singular and may include the plural. In general, the terms “comprise,” “comprises,” “comprising,” “include,” “includes,” and/or “including,” merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

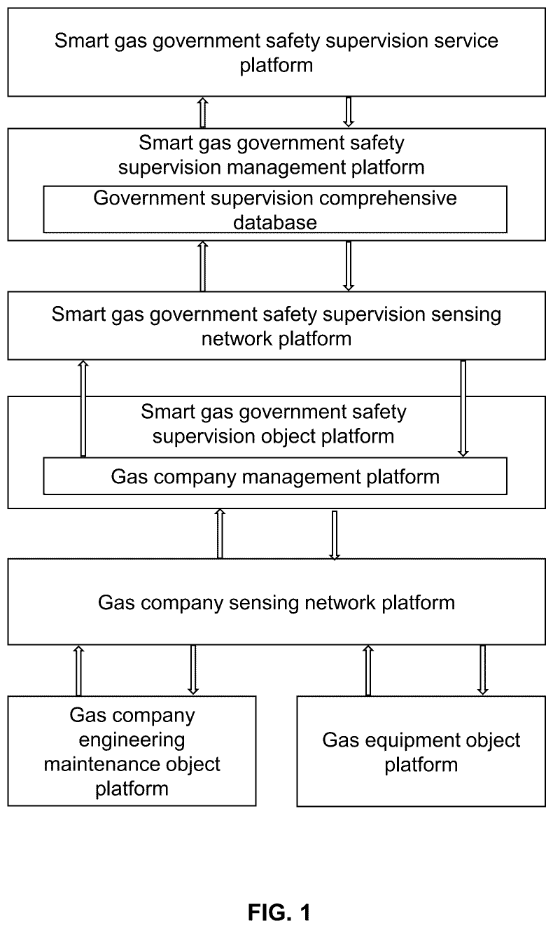

FIG. 1 is a diagram illustrating an exemplary platform structure of a system for supervising safety ventilation of an underground gas pipeline corridor based on Internet of Things (IoT) according to some embodiments of the present disclosure.

As shown in FIG. 1, the system for supervising safety ventilation of an underground gas pipeline corridor based on Internet of Things (IoT) includes a smart gas government safety supervision service platform, a smart gas government safety supervision management platform, a smart gas government safety supervision sensing network platform, a smart gas government safety supervision object platform, a gas company sensing network platform, and a gas equipment object platform.

The smart gas government safety supervision service platform is a platform used by the government to provide services to users, conduct business cooperation with other platforms, and share data. Other platforms may include related platforms used for electric power supply management and/or water supply management, etc.

The smart gas government safety supervision service platform may send the corrosion reaction degree of the pipeline corridor segment, etc. to other platforms. The pipeline corridor includes relevant lines of a relevant platform for power supply management and/or a relevant platform for water supply management, etc.

The smart gas government safety supervision management platform is a platform used by the government to coordinate and harmonize the linkage and collaboration between various functional platforms and converge all the information of the underground gas pipeline corridor to provide perception management and control management functions for the operation and maintenance of the gas pipeline corridor. As the underground gas pipeline corridor is public infrastructure, the ownership of the underground gas pipeline corridor is vested in the government. Government departments (e.g., the emergency management agency) may know the safety level of the underground gas pipeline corridor and the implementation of safety management through the smart gas government safety supervision management platform. When corrosion occurs in the underground gas pipeline corridor, the government departments may be informed of safety hazards due to corrosion promptly.

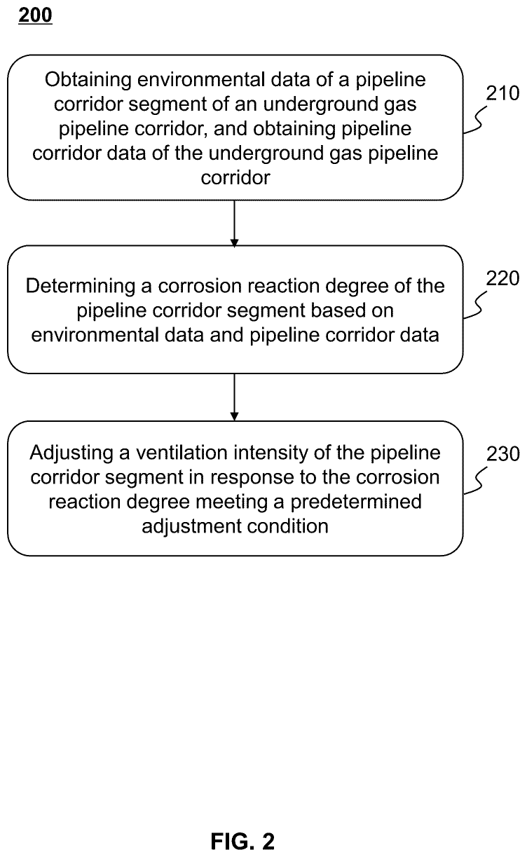

In some embodiments, the smart gas government safety supervision management platform may include a government supervision comprehensive database. The government supervision comprehensive database stores pipeline corridor data including, but not limited to, ventilation data, structural data, distribution sequence data, a type of pipeline, a count of the pipeline, a location of the pipeline, historical maintenance data, and attribute information of the pipeline corridor segment, etc. As the underground gas pipeline corridor is being constructed and built, the pipeline corridor data is obtained by the survey unit, the design unit, the construction unit, etc., and is reported to the government departments for the record. After the underground gas pipeline corridor is put into use, using units (e.g., gas companies, etc.) may obtain the pipeline corridor data from the government supervision comprehensive database when using the pipeline corridor data. More descriptions regarding the pipeline corridor data may be found in FIG. 2 and the related descriptions thereof.

In some embodiments, the smart gas government safety supervision management platform may transmit the pipeline corridor data in the government supervision comprehensive database to a gas company management platform via the smart gas government safety supervision sensing network platform.

The smart gas government safety supervision sensing network platform is a functional platform that realizes sensing communication for sensing information and sensing communication for controlling information. The smart gas government safety supervision sensing network platform may interact with the smart gas government safety supervision management platform and the gas company management platform.

In some embodiments, the smart gas government safety supervision sensing network platform may obtain the corrosion reaction degree From the gas company management platform and transmit it to the smart gas government safety supervision management platform. As the underground pipeline corridor is often accompanied by other pipelines (such as water and sewage pipelines, electrical pipelines, etc.), when maintaining and repairing the gas pipeline, collaborating with other departments or units is often necessary. Therefore, when a pipeline corridor segment is found to be severely corroded, a safety management status of the pipeline corridor segment and related information may be reported to the smart gas government safety supervision management platform. The smart gas government safety supervision management platform is responsible for the unified coordination of emergency rescue and repair work.

The smart gas government safety supervision object platform is a functional platform for sensing the generation of safety supervision information and controlling the execution of safety supervision information. The smart gas government safety supervision object platform may include the gas company management platform. The gas company management platform refers to a platform that monitors the operating conditions of the gas pipeline corridor and is responsible for the maintenance and repair of the underground gas pipeline corridor and the related ancillary facilities. The gas company management platform has the right to use the underground gas pipeline corridor. The gas company management platform may determine the corrosion reaction degree of the pipeline corridor segment based on environmental data and pipeline corridor data, and adjust a ventilation intensity of the pipeline corridor segment in response to the corrosion reaction degree meeting a predetermined adjustment condition.

In some embodiments, the gas company management platform may send commands for obtaining maintenance effects of different pipeline corridor segments to a gas company engineering maintenance object platform through the gas company sensing network platform and receive the uploaded maintenance effects of the different pipeline corridor segments.

The gas company sensing network platform may be a functional platform for managing sensing communications. The gas company sensing network platform may be a functional platform for mutual communication between the gas equipment object platform and the gas company management platform.

In some embodiments, the gas equipment object platform may send the environmental data to the gas company management platform via the gas company sensing network platform. The gas equipment object platform may adjust the ventilation intensity of a pipeline corridor segment corresponding to the underground gas pipeline corridor based on the received ventilation intensity adjustment command. The gas company management platform may adjust the ventilation intensity of the pipeline corridor segment based on the corrosion reaction degree meeting the predetermined adjustment condition, and transmit the instruction for adjusting the ventilation intensity to the gas equipment object platform through the gas company sensing network platform. The gas equipment object platform may include a plurality of devices, such as one or more of a temperature sensor, a humidity sensor, a gas concentration detector, a mechanical ventilation device, a groundwater monitoring device, or the like.

In some embodiments, the system for supervising the safety ventilation of the underground gas pipeline corridor based on IoT further includes the gas company engineering maintenance object platform. The gas company engineering maintenance object platform is configured as a platform that is responsible for the maintenance of the different pipeline corridor segments and the communication of information related to the maintenance. The gas company engineering maintenance object platform may monitor the maintenance effects of different pipeline corridor segments and generate related maintenance effect data. The gas company engineering maintenance object platform may send the generated maintenance effect data to the gas company management platform via the gas company sensing network platform.

In some embodiments, the gas company management platform may determine an estimated time period for which the predicted corrosion degree of the pipeline corridor segment meets a predetermined corrosion condition; and determine a subsequent maintenance program for the pipeline corridor segment based on the estimated time period, an importance level of the pipeline corridor segment, and the historical maintenance data of the pipeline corridor segment and send the subsequent maintenance program to the gas company engineering maintenance object platform via the gas company sensing network platform.

In some embodiments, the gas company management platform may obtain the maintenance effect of the pipeline corridor segment via the gas equipment object platform; determine an adjusted duration of the ventilation intensity based on the estimated time period and the maintenance effect, and send the adjusted duration to the gas equipment object platform.

More descriptions of the above may be found in FIG. 2 to FIG. 4 below.

FIG. 2 is an exemplary flowchart illustrating a method for supervising safety ventilation of an underground gas pipeline corridor based on Internet of Things (IoT) according to some embodiments of the present disclosure. In some embodiments, process 200 may be performed by a gas company management platform.

In 210, environmental data of a pipeline corridor segment of the underground gas pipeline corridor is obtained, and pipeline corridor data of the underground gas pipeline corridor is obtained.

The underground gas pipeline corridor is an underground tunnel space where gas pipelines are laid. The underground gas pipeline corridor is provided with facilities such as a ventilation opening, a maintenance opening, a lifting opening, and an environmental monitoring system. The environmental monitoring system is the relevant equipment configured to monitor the environmental data and is attributed to the gas equipment object platform. For example, the environmental monitoring system may include a temperature sensor, a humidity sensor, and a gas concentration detector, etc.

The pipeline corridor segment is a segmented pipeline corridor region between every two vents in an underground gas pipeline corridor. A count of the pipeline corridor segment of the underground gas pipeline corridor may be one or more, and a single pipeline corridor segment may be the smallest unit for ventilation management of the underground gas pipeline corridor.

The environmental data refers to environmental parameters within the underground gas pipeline corridor. In some embodiments, the environmental data may include temperature, humidity, carbon dioxide concentration, etc.

In some embodiments, the gas company management platform obtains the environmental data from the gas equipment object platform via a gas company sensing network platform. For example, via the gas company sensing network platform, the gas company management platform may obtain temperature data from a temperature sensor of the gas equipment object platform, humidity data from a humidity sensor of the gas equipment object platform, and carbon dioxide concentration data from a gas concentration detector of the gas equipment object platform.

The pipeline corridor data refers to data used for pipeline corridor management. For example, the pipeline corridor data may reflect construction, operation, and maintenance of the pipeline corridor In some embodiments, the pipeline corridor data may include ventilation data, structural data, and distribution sequence data, among others.

The ventilation data refers to relevant data used to indicate the ventilation of the pipeline corridor. In some embodiments, the ventilation data includes locations of vents, a count of vents, locations of fans, a count of fans, or the like.

The structural data refers to relevant data used to indicate the structure of the pipeline corridor. In some embodiments, the structural data includes a dimension of the pipeline corridor and a burial depth of the pipeline corridor, etc. The burial depth of the pipeline corridor refers to a distance from a bottom of the pipeline corridor to the ground. The burial depth of the pipeline corridor may be the same or different for different pipeline corridor segments.

The distribution sequence data refers to relevant data used to indicate the distribution of groundwater. The distribution sequence data may be relevant data characterizing temporal changes in the distribution of groundwater corresponding to one or more pipeline corridor segments in a predetermined region, and the distribution sequence data may include distribution information of groundwater of the one or more pipeline corridor segments at a plurality of consecutive time points. The distribution sequence data may be relevant data characterizing temporal changes in the distribution of groundwater in one pipeline corridor segment, and the distribution sequence data may include the distribution information of groundwater of the pipeline corridor segment at a plurality of consecutive time points. For example, the distribution sequence data corresponding to a pipeline corridor segment may include a water level height of the groundwater in the pipeline corridor segment or the burial depth of the groundwater in the pipeline corridor segment at the plurality of consecutive time points. The water level height of the groundwater refers to a height of the water surface of the groundwater relative to a datum (e.g., sea level). The burial depth of the groundwater refers to a distance from the water surface of the groundwater to the ground surface.

In some embodiments, the pipeline corridor data is stored in a government supervision comprehensive database in the smart gas government safety supervision management platform. The ventilation data and structural data are collected and uploaded by a construction organization of the underground gas pipeline corridor. The smart gas government safety supervision management platform may receive and store the ventilation data and structural data in a government supervision comprehensive database. The distribution sequence data refers to data collected and uploaded automatically or manually regularly by a groundwater monitoring agency through a groundwater monitoring device. The smart gas government safety supervision management platform may receive and store the distribution sequence data in the government supervision comprehensive database.

In some embodiments, the gas company management platform obtains the pipeline corridor data from the government supervision comprehensive database of the smart gas government safety supervision management platform via the smart gas government safety supervision management platform.

In 220, a corrosion reaction degree of the pipeline corridor segment is determined based on the environmental data and the pipeline corridor data.

The corrosion reaction degree refers to the progression of a corrosion reaction associated with a corrosive gas. The corrosive gas refers to a gas capable of eroding an internal structure of the pipeline corridor. For example, the corrosive gas may include acidic gas, alkaline gas, or the like. The corrosion reaction degree indicates the severity of the chemical reaction between the corrosive gas and the internal structure of the pipeline corridor.

The corrosion reaction degree may be expressed in various forms. For example, the corrosion reaction degree may indicate the severity of the chemical reaction occurring in the pipeline corridor segment through numerical values or grades. The higher the numerical value, the more severe the chemical reaction. The corrosion reaction degree may also be represented in vector form, with each element of the vector representing the severity of the chemical reaction occurring in various pipeline corridor segments.

The gas company management platform may determine the corrosion reaction degree of the pipeline corridor segment in various ways based on the environmental data and the pipeline corridor data. For example, the corrosion reaction degree of the pipeline corridor segment may be determined based on the environmental data and the pipeline corridor data through vector matching in a vector database. The vector database may include a plurality of reference vectors, which are constructed based on historical pipeline corridor data, historical environmental data, and a historical corrosion reaction degree of the pipeline corridor segment. The gas company management platform may construct a query feature vector based on current pipeline corridor data and environmental data of the pipeline corridor segment, determine a target vector that meets a vector preset condition among the plurality of reference vectors in the vector database based on the query feature vector, and determine the historical corrosion reaction degree Corresponding to the target vector as the corrosion reaction degree of the pipeline corridor segment. The vector preset condition refers to a judgment condition for determining the target vector. The vector preset condition may be related to a distance between the reference vector and the query feature vector. For example, the vector preset condition may be that the distance between vectors is less than a predetermined threshold, or the distance is minimal, etc.

In some embodiments, the gas company management platform may predict a predicted sequence set of the pipeline corridor segment in a future time period based on the environmental data and the pipeline corridor data; and in response to the predicted sequence set meeting a predetermined warning condition, issue a warning message to the smart gas government safety supervision management platform via the smart gas government safety supervision sensing network platform.

The future time period refers to a period of time that starts at a current time point. The future time period may include a plurality of future time points.

The predicted sequence set refers to a set of sequences reflecting the corrosion reaction degree of one or more pipeline corridor segments in the future time period. The predicted sequence set may include values for the predicted corrosion degree of the one or more pipeline corridor segments at the plurality of future time points. The predicted corrosion degree refers to a forecasted corrosion reaction degree.

The gas company management platform may dynamically predict the predicted sequence set based on the environmental data and the pipeline corridor data using various manners, such as statistical manners, etc. The predicted sequence set may be obtained by processing related data using manners such as fitting and least squares. For example, the predicted sequence set may be obtained by a fitting formula based on predicted environmental data, predicted distribution sequence data, current ventilation data, and current structural data. The predicted environmental data of a plurality of future time points may be obtained from remote databases (e.g., a publicly available database of a weather forecasting agency), and predicted distribution sequence data of a plurality of future time points may be obtained from remote databases (e.g., a publicly available database of a groundwater monitoring agency). The fitting formula is constructed by nonlinear fitting based on the historical environmental data, the historical distribution sequence data, the historical ventilation data, the historical structural data, and the historical corrosion reaction degree.

In some embodiments, the gas company management platform may predict the predicted sequence set based on the environmental data, the pipeline corridor data, and a pipeline corrosion protection property through a corrosion reaction model.

The pipeline corrosion protection property refers to data indicating the maintenance of the corridor against corrosion. The pipeline corrosion protection property may be determined based on a corrosion protection level of the internal structure of the pipeline corridor. For example, if the corrosion protection level of the gas pipeline inside the pipeline corridor is level 1, level 2, or level 3 according to a construction design standard, then the pipeline corrosion protection property corresponds to 1, 2, or 3, respectively. The pipeline corrosion protection property of the pipeline corridor may be determined based on integrity of an anti-corrosion coating of the internal structure. For example, the integrity of the anti-corrosion coating gradually decreases over time between the end of the previous anti-corrosion maintenance and the next anti-corrosion maintenance, and the gas company management platform may determine the pipeline corrosion protection property based on an interval between the current time and the latest anti-corrosion maintenance time by using a corrosion protection property calculation formula. The corrosion protection property calculation formula is constructed by nonlinear fitting based on time data and anti-corrosion coating integrity data after anti-corrosion coating treatment. The time data and anti-corrosion coating integrity data after anti-corrosion coating treatment may be collected experimentally and uploaded to the gas company management platform.

In some embodiments, the corrosion reaction model is a machine learning model. The corrosion reaction model is one of a neural network model, a support vector machine model, a plain Bayesian model, etc., or any combination thereof.

In some embodiments, an input of the corrosion reaction model may include the environmental data, the pipeline corridor data, and the pipeline corrosion protection property, and an output of the corrosion reaction model may be the predicted sequence set of the pipeline corridor segment in the future time period.

In some embodiments, the corrosion reaction model may be obtained by training a plurality of first training samples with a first label. The plurality of first training samples with the first label may be input into an initial corrosion reaction model. A loss function is constructed based on the first label and results of the initial corrosion reaction model, and parameters of the initial corrosion reaction model are updated by iteration based on the loss function. The model training is completed when the loss function of the initial corrosion reaction model satisfies a predetermined iteration condition, and the trained corrosion reaction model is obtained. The predetermined iteration condition may include that the loss function converges and a count of the iteration reaches a threshold, etc.

In some embodiments, the first training sample may include historical environmental data, historical pipeline corridor data, and historical pipeline corridor corrosion protection data of the pipeline corridor segment. The first label may be an actual corrosion reaction degree of the pipeline corridor segment at a historical time point. For example, the first label may be obtained through manual labeling.

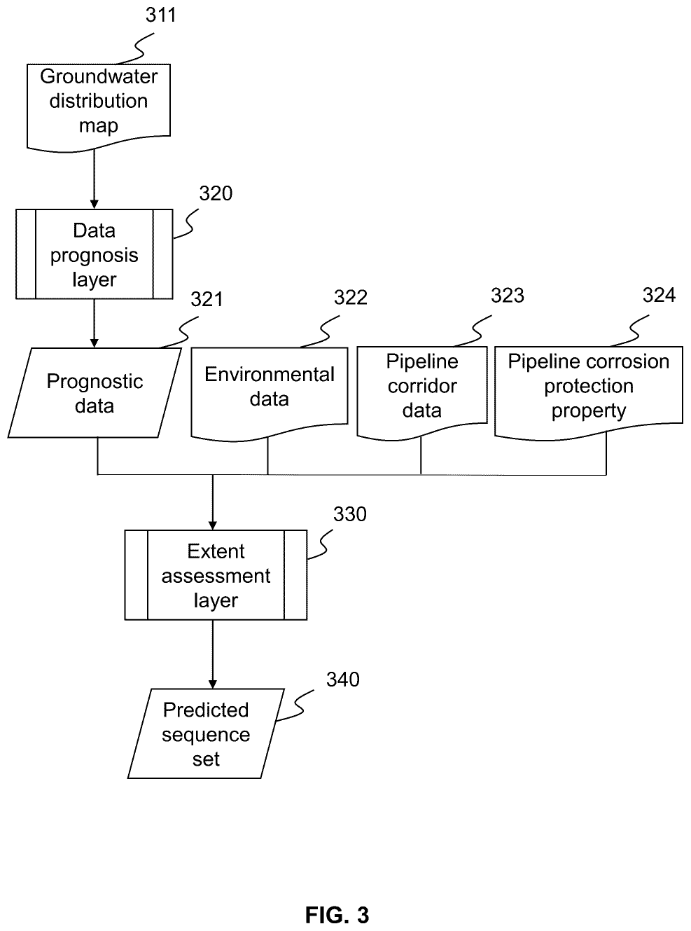

In some embodiments, the corrosion reaction model may include a data prognosis layer and an extent assessment layer, as more fully described in FIG. 3 and its related description.

By predicting the predicted sequence set through the corrosion reaction model, the efficiency of obtaining the predicted sequence set increases. By iterating the corrosion reaction model through the update of training samples, the accuracy and reliability of the prediction results may be improved.

In some embodiments, the gas company management platform may determine whether the predicted sequence set satisfies the predetermined warning condition.

The predetermined warning condition refers to a judgment condition for determining that the predicted corrosion degree at each future time point in the predicted sequence set exceeds an acceptable range. For example, the predetermined warning condition is that the predicted corrosion degree exceeds a reaction threshold. The reaction threshold is the minimum value that the predicted corrosion degree needs to reach for an alert to be issued. The reaction threshold input by a user may be preset or received. The reaction threshold may be manually preset based on information such as geographic conditions, historical pipeline corridor operation and maintenance data, etc.

In some embodiments, the gas company management platform may determine whether the predicted corrosion degree at each future time point of different pipeline corridor segments in the predicted sequence set is greater than or equal to the reaction threshold, and in response to the predicted corrosion degree at the future time point of any pipeline corridor segment greater than or equal to the reaction threshold, issue an early warning message.

The warning message is used to indicate a possible risk of corrosion reactions. For example, the warning message may include the pipeline corridor segment with a risk of corrosion, a predicted occurrence time (corresponding to the future time point at which the corrosion is predicted to occur in the pipeline corridor segment), and other predefined risk alert information.

In some embodiments, in response to the predicted sequence set meeting the predetermined warning condition, the gas company management platform may generate a warning message and send it to the smart gas government safety supervision management platform via the smart gas government safety supervision sensing network platform, so that the smart gas government safety supervision management platform may then send the warning message to other platforms related to the use and maintenance of the underground gas pipeline corridor.

By dynamically predicting the corrosion reaction degree of different pipeline corridor segments in the future time period, managers of the smart gas government safety supervision management platform may notify operation and maintenance personnel of the gas company in advance to make preparations for operation and maintenance of the pipeline corridor, to avoid possible safety hazards in the pipeline corridor.

In 230, the ventilation intensity of the pipeline corridor segment is adjusted in response to the corrosion reaction degree meeting the predetermined adjustment condition.

The predetermined adjustment condition refers to a condition used to determine whether to adjust the ventilation intensity of the pipeline corridor segment. For example, the predetermined adjustment condition is a condition for adjusting the ventilation intensity of a pipeline corridor segment when the corrosion reaction degree of the pipeline corridor segment is greater than a corrosion reaction threshold. The corrosion reaction threshold refers to the minimum value of the corrosion reaction degree For which the ventilation intensity is to be adjusted. The corrosion reaction threshold may be preset according to actual needs.

The ventilation intensity is a metric reflecting the operation intensity of mechanical ventilation devices corresponding to the different pipeline corridor segments. In some embodiments, the ventilation intensity may include a ventilation volume and/or a ventilation efficiency.

In some embodiments, the ventilation intensity of the corresponding pipeline corridor segment may be adjusted in various ways based on the corrosion reaction degree meeting a predetermined adjustment condition. For example, after determining the corrosion reaction degree of the corresponding pipeline corridor segment that meets the predetermined adjustment condition, a ventilation intensity matching that corrosion reaction degree may be determined by querying a first preset table, with that ventilation intensity as the ventilation intensity of the pipeline corridor segment. A mapping relationship between different corrosion reaction degrees and different ventilation intensities may be stored in the first preset table.

In some embodiments, the gas company management platform may send instructions for adjusting the ventilation intensity to the gas equipment object platform via the gas company sensing network platform. For example, the instructions for adjusting the ventilation intensity may be sent to a mechanical ventilation device corresponding to a pipeline corridor segment in the gas equipment object platform that needs to be adjusted for the ventilation intensity, and the mechanical ventilation device receives the instructions and then adjust the ventilation volume and/or ventilation efficiency.

When there is more than one pipeline corridor segment requiring ventilation intensity adjustment, the ventilation intensity may be adjusted individually for each pipeline corridor segment.

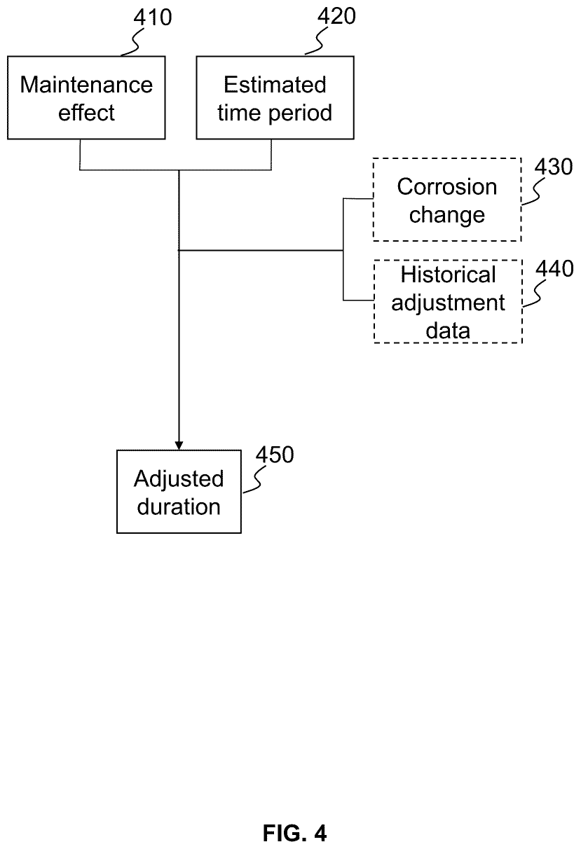

In some embodiments, the gas company management platform may determine an adjusted duration of the ventilation intensity based on the estimated time period and the maintenance effect, as more may be found in FIG. 4 and its related description.

In some embodiments of the present disclosure, determining the corrosion reaction degree of the pipeline corridor segment based on the pipeline corridor data and the environmental data, and then adjusting the ventilation intensity of the pipeline corridor segment when needed, enables control of ventilation based on the actual conditions within the underground gas pipeline corridor, ensuring the safe and reliable operation of the gas pipeline. Compared to the management of the unified ventilation management of the underground gas pipeline corridor based on a single factor, this method takes into account the stratigraphic differences, differences in the level of the pipeline corridor construction and maintenance, environmental differences, etc., and is able to carry out targeted dynamic management of each pipeline corridor segment of the underground gas pipeline corridor, which reduces the operating costs and maintenance difficulties of the ventilation management of the underground gas pipeline corridor.

In some embodiments, the gas company management platform may determine the estimated time period in which the predicted corrosion degree of the pipeline corridor segment meets the predetermined corrosion condition; and determine the subsequent maintenance program for the pipeline corridor segment based on the estimated time period, the importance level of the pipeline corridor segment, and the historical maintenance data for the pipeline corridor segment.

More descriptions regarding the predicted corrosion degree may be found in related descriptions in FIG. 2.

The predetermined corrosion condition refers to a critical corrosion condition that determines the corrosion degree of the pipeline corridor segment that may have an impact on the safety of the gas pipeline corridor. The predetermined corrosion condition may be that the predicted corrosion degree reaches the reaction threshold, etc. More descriptions regarding the reaction threshold may be found in related descriptions of FIG. 2.

The estimated time period refers to an expected duration at which the predicted continued corrosion of the pipeline corridor segment meets the predetermined corrosion conditions.

The gas company management platform may determine the estimated time period in a plurality of ways. For example, the gas company management platform may determine the estimated time period via the predicted sequence set. The estimated time period is determined as an interval between a future time point at which the predicted corrosion degree in the predicted sequence set reaches the reaction threshold and the current time point. If the corrosion reaction degree at the current time point has already reached the reaction threshold, the estimated time period is set to 0.

In some embodiments, the estimated time period may be determined based on the predicted sequence set and prognostic environmental data. More descriptions regarding the prognostic environmental data may be found in related descriptions of FIG. 3.

In some embodiments, the gas company management platform may determine the magnitude of environmental change based on the prognostic environmental data. The magnitude of the environmental change may characterize the extent of the environmental change.

In some embodiments, the estimated time period may be negatively correlated with the magnitude of the environmental change, i.e., the greater the magnitude of the environmental change, the greater the tendency of the pipeline corridor to corrosion, and the shorter the estimated time period.

Exemplarily, the estimated time period may be obtained based on the following equation:

$$T = t \times {e}^{- \frac{x}{10}}$$

Where T denotes the estimated time, t denotes the expected duration determined based on the predicted sequence set, and x denotes the magnitude of environmental change.

Determining the estimated time period by taking into account the prognostic environmental data in a comprehensive manner may improve the accuracy and reliability of the prediction of the estimated time period, and ensure that the results of the prediction are more in line with the actual situation.

The importance level of the pipeline corridor segment may characterize the extent to which a particular pipeline corridor segment needs to be prioritized for monitoring and maintenance. The importance level may be expressed as a numerical value or a level, e.g., the higher the value, the more important the pipeline corridor segment is, and the more frequently it needs to be monitored and maintained.

In some embodiments, the importance level relates to the type of pipeline corridor segment, the count of the pipeline, and the location of the pipeline. The type of pipeline refers to whether the pipeline corridor segment is a main trunk line or a branch line. The count of the pipeline refers to the count of the pipeline inside the pipeline corridor segment and a count of relevant pipeline equipment. The location of the pipeline refers to a geographic location where the pipeline corridor segment is located. The relevant pipeline equipment may include gas pressure regulating equipment, gas monitoring equipment, etc. The geographic location may include a residential region, an industrial region, a suburban region, etc.

In some embodiments, the importance level of the pipeline corridor segment may be determined based on a preset correspondence based on the type of the pipeline, the count of the pipeline, and the location of the pipeline. The preset correspondence refers to a correspondence between the importance level and the type of the pipeline, the count of the pipeline, and the location of the pipeline, which is predetermined. Exemplarily, the preset correspondence includes that the more branches of the pipeline corridor segment, the more count of the pipeline and pipeline equipment inside, and the more count of people in the geographic location, the more important the pipeline corridor segment is, and the more higher the importance level is. The information on the type of the pipeline, the count of the pipeline, and the location of the pipeline may be obtained by the gas company management platform from the government supervision comprehensive database via the smart gas government safety supervision sensing network platform.

The historical maintenance data refers to maintenance data generated by past maintenance of the gas pipeline corridor. The historical maintenance data may include a maintenance time of the pipeline corridor segment, a location of the pipeline corridor segment, a maintenance manner, a maintenance result, etc. The gas company management platform may obtain the historical maintenance data from the government supervision comprehensive database via the smart gas government safety supervision sensing network platform.

The subsequent maintenance program refers to a planned maintenance program for different pipeline corridor segments. The subsequent maintenance program may include a subsequent maintenance sequence, a start time for the maintenance, an estimated time for the maintenance, necessary maintenance personnel, specific maintenance steps, etc. The subsequent maintenance sequence refers to an order of maintenance for the pipeline corridor. For example, the subsequent maintenance program may initially focus on the pipeline corridor with a high importance level or a high corrosion reaction degree.

The subsequent maintenance program may be determined in a plurality of ways. For example, the gas company management platform may determine, based on the estimated time period, the importance level, and the historical maintenance data of one or more pipeline corridor segments, subsequent maintenance programs corresponding to the one or more pipeline corridor segment by querying a second preset table. The second preset table may include correlations between the estimated time period, the importance level, and the historical maintenance data of different pipeline corridor segments, as well as the subsequent maintenance program. The second preset table may be preset based on historical data or a prior knowledge.

In some embodiments, the gas company management platform may determine the subsequent maintenance sequence based on the expected duration, the importance level, and the historical maintenance data by calculating a maintenance score. The maintenance score may be a sum of an expected duration score, an importance level score, and a historical maintenance data score. The gas company management platform may sort the maintenance scores of different gas pipeline corridors based on numerical value and determine the obtained sorting sequence as the subsequent maintenance sequence.

In some embodiments, the shorter the expected duration, the greater the expected duration score. When the expected duration is 0, the corrosion reaction degree has reached the reaction threshold, and the expected duration score reaches the maximum value of 1. The higher the importance level of the pipeline corridor segment, the higher the importance level score, capped at 1. The more historical maintenance data the pipeline corridor segment has, the greater the historical maintenance data score. When the pipeline corridor segment reaches a preset maintenance count threshold, the historical maintenance data score reaches the maximum value of 1.

When the operation and maintenance personnel of the underground gas pipeline corridor are limited, rationally arranging the maintenance sequence of different pipeline corridor segments is effective in improving the efficiency of the operation and maintenance and ensuring the quality of the operation and maintenance. The present embodiment reasonably predicts the duration that the corrosion reaction degree of different pipeline corridor segments reaches the reaction threshold by taking into account the prognostic environmental data, and determines the subsequent maintenance sequence of different pipeline corridor segments based on the predicted time. The embodiment ensures that the more important pipeline corridor segments are maintained on time, while the less important pipeline corridor segments that are more remote may be maintained at a lower frequency, thus ensuring the safety of the pipeline corridor operation.

It should be noted that the foregoing description of the process 200 is intended to be merely exemplary and illustrative, and does not limit the scope of application of the present disclosure. For those skilled in the art, various corrections and changes may be made to the process 200 under the guidance of this disclosure. However, these corrections and changes remain within the scope of the present disclosure.

FIG. 3 is a schematic schematic illustrating an exemplary corrosion reaction model according to some embodiments of the present disclosure.

In some embodiments, the corrosion reaction model may include a data prognosis layer 320 and an extent assessment layer 330, as shown in FIG. 3.

In some embodiments, the data prognosis layer 320 refers to a machine learning model for determining prognostic data. The data prognosis layer 320 may be a graph neural network (GNN), etc. The extent assessment layer 330 refers to a machine learning model for processing the data and outputting a predicted sequence set. The extent assessment layer 330 may be a model such as a neural network (NN).

In some embodiments, an input of the data prognosis layer 320 may be a groundwater distribution map 311, and an output of the data prognosis layer 320 is prognostic data 321. The prognostic data 321 is an output from a node (at least one groundwater monitoring node) in the data prognosis layer. The output is the prognostic data for at least one future time point corresponding to at least one groundwater monitoring location. The groundwater monitoring location may be configured with one or more groundwater monitoring devices.

The prognostic data refers to the distribution sequence data of groundwater obtained through prediction. The prognostic data of the groundwater includes distribution information of the groundwater at one or more future time points. More detailed descriptions regarding the distribution sequence data may be found in FIG. 2 and the related descriptions thereof.

The groundwater distribution map 311 refers to a representation of distribution characteristics of the groundwater in a geological structure. The distribution map may reflect characteristics of the distribution of the groundwater.

The groundwater distribution map 311 may include at least one node and at least one edge. The node includes a pipeline corridor segment node and a groundwater monitoring node. The pipeline corridor segment node includes a node attribute information of the pipeline corridor segment, and each pipeline corridor segment has a corresponding pipeline corridor segment node. The node attributes of the pipeline corridor segment node may include a geographic location of the pipeline corridor segment, stratigraphic information near the pipeline corridor, a length of the pipeline corridor segment, etc. The groundwater monitoring node corresponds to the groundwater monitoring location. The node attributes of the groundwater monitoring node include a geographic location of the groundwater monitoring location, equipment and manner for monitoring the groundwater, distribution information of the groundwater, stratigraphic information near the groundwater monitoring location, groundwater quality information obtained from monitoring, etc.

The edge in the groundwater distribution map 311 may represent relationships between different nodes. The edge attribute includes distance, and a distance between two nodes may reflect a correlation degree between the two nodes, with a shorter distance indicating a higher correlation degree. When the distance between two nodes is less than a distance threshold, the nodes are connected with edges. The distance threshold may be determined based on prior experience.

The gas company management platform may obtain the attribute information of the pipeline corridor segment node from the government supervision comprehensive database via the smart gas government safety supervision sensing network platform. The gas company management platform may obtain attribute information of the groundwater monitoring node from the gas equipment object platform via the gas company sensing network platform.

In some embodiments, the data prognosis layer may be obtained by training an initial data prognosis layer based on a plurality of second training samples with a second training label. The second training samples may include a sample groundwater distribution map corresponding to a sample pipeline corridor.

The second training label may be the actual data of the groundwater corresponding to the sample pipeline corridor. The second training sample may be determined based on the construction of actual monitoring data of the groundwater at a first historical time point or may be determined based on the construction of simulated monitoring data of simulated groundwater. The second training label may be obtained through automatic labeling or manual labeling. For example, actual monitoring data (e.g., actual burial depth of the groundwater, etc.) at the second time point of the groundwater monitoring location may be determined and labeled manually as the second training label. The second time point is located after the first time point and represents a future time point of the first time point. The training process of the data prognosis layer is similar to that of the corrosion reaction model. More detailed descriptions may be found in related descriptions of FIG. 2.

In some embodiments, an input of the extent assessment layer 330 may include prognostic data 321, environmental data 322, pipeline corridor data 323, and pipeline corrosion protection property 324, etc., and an output of the extent assessment layer 330 may be predicted sequence set 340.

In some embodiments, environmental data 322 may also include the prognostic environmental data. The prognostic environmental data refers to environmental data for a future time point. The gas company management platform may access the prognostic environmental data through a plurality of manners. For example, current environmental data may be combined with historical environmental data and fitted using multiple linear regression to obtain prognostic environmental data for the future time point.

More detailed descriptions regarding the environmental data, the pipeline corridor data, the pipeline corrosion protection property, and the predicted sequence set may be found in FIG. 2 and its related descriptions.

In some embodiments, the extent assessment layer may be obtained by training an initial extent assessment layer based on a plurality of third training samples with a third training label. The third training samples may include actual data of sample groundwater corresponding to a sample pipeline corridor, sample environmental data, sample pipeline corridor data, and sample pipeline corrosion protection property.

The third training label may be a set of sample actual sequences corresponding to the sample pipeline corridor. The third training sample and the third training label are determined based on historical operation and maintenance data generated by the gas pipeline corridor. For example, actual data of groundwater, actual environmental data, actual pipeline corridor data, and actual pipeline corrosion protection property are used as the third training samples in the historical operation and maintenance process. The corrosion reaction degree of the pipeline corridor, which is surveyed on-site by the gas pipeline corridor maintenance personnel, is determined as the third training label and manually labeled.

The corrosion reaction degree of the pipeline corridor may reflect the corrosive influence of the pipeline, the degree of influence on the normal operation of the pipeline corridor. The corrosion reaction degree of the pipeline corridor may be expressed in terms of a numerical value or level. For example, the higher the breakage degree of the corrosion protection coating on the surface of the pipeline corridor, the higher the count of failures of the pipeline corridor and related equipment, and the older the appearance, the higher the numerical value of the corrosion reaction degree of the pipeline corridor. The gas pipeline corridor maintenance personnel may determine the corrosion reaction degree of the pipeline corridor based on the appearance of the pipeline corridor and its related equipment, the normal functional operation, the integrity of corrosion protection coating on the surface of the pipeline corridor, etc.

The training process for the extent assessment layer is similar to that of the corrosion reaction model, and more descriptions may be found in the related description in FIG. 2.

Based on the groundwater distribution map, by utilizing the data prognosis layer and the extent assessment layer in combination, the data prognosis layer may excavate the groundwater prognostic data more accurately. Moreover, by eliminating the interference generated by the invalid information on the corrosion reaction model, the accuracy and reliability of the predicted sequence set predicted by the extent assessment layer may be enhanced. It is favorable for the operation and maintenance personnel to prepare the pipeline corridor operation and maintenance in advance based on the prediction results, to avoid possible pipeline corridor safety hazards.

FIG. 4 is a schematic diagram illustrating an exemplary process of determining an adjusted duration according to some embodiments of the present disclosure.

As shown in FIG. 4, the gas company management platform may obtain a maintenance effect 410 of the pipeline corridor segment via the gas company sensing network platform through the gas company engineering maintenance object platform and determine an adjusted duration 450 of a ventilation intensity based on an estimated time period 420 and the maintenance effect 410.

More descriptions regarding the pipeline corridor segment and the estimated time period may be found elsewhere in the present disclosure, e.g., FIG. 2, FIG. 3, and related descriptions thereof.

The maintenance effect refers to the effect of maintaining the underground gas pipeline corridor. The maintenance effect may include an anti-corrosion effect and an anti-seepage effect, etc. The maintenance effect is determined by maintenance personnel of the underground gas pipeline corridor. For example, the maintenance effect is determined by regular inspection and record and is recorded into the gas company engineering maintenance object platform.

The adjusted duration is a duration for which the ventilation intensity is adjusted.

In some embodiments, the gas company management platform may classify an adjustment level for the pipeline corridor segment based on an estimated time period and the maintenance effect, and determine an adjusted duration that matches the adjustment level by querying a third preset table, and designate the matched adjusted duration as the adjusted duration of the adjustment of the ventilation intensity of the pipeline corridor segment. A mapping relationship between the estimated time period, the maintenance effect, and the adjusted duration is stored in the third preset table.

When there is more than one pipeline corridor segment that needs to be adjusted in terms of ventilation intensity, the gas company management platform may adjust the adjusted duration of the ventilation intensity for each pipeline corridor segment.

Determining the adjusted duration of the ventilation intensity based on the estimated time period and the maintenance effect allows the adjustment of the ventilation intensity to be controlled within a suitable range. Determining a suitably adjusted duration allows the methods provided in the embodiments of the present disclosure to strike a balance between safeguarding effectiveness and conserving resources.

In some embodiments, the gas company management platform may correct the adjusted duration based on a corrosion change 430 of the pipeline corridor segment. The time point for correcting the adjusted duration may be a time point when the gas equipment object platform executes an instruction to adjust the ventilation intensity.

The corrosion change 430 is information reflecting the magnitude of change in a corrosion rate of the pipeline corridor segment at different time points. The different time points may be at least one future time point from the current time point.

In some embodiments, the gas company management platform may determine the corrosion change of the pipeline corridor segment at the future time point based on a reference corrosion rate and a corrosion rate of the pipeline corridor segment at the future time point. Exemplarily, an adjusted corrosion rate of the pipeline corridor segment may be calculated at the future time point, and a difference in corrosion rate at the future time point may be determined based on the adjusted corrosion rate and the reference corrosion rate. The gas company management platform may use the corrosion rate difference at the future time point as the corrosion change at the future time point. The corrosion rate difference may be positive, negative, or zero.

The adjusted corrosion rate is a change rate of the corrosion reaction degree of the pipeline corridor segment from a historical time point to a future time point. The historical time point may be any time point after the gas equipment object platform executes the instruction to adjust the ventilation intensity to the future time point, such as an initial point at which the adjustment instruction is executed or a fixed time interval from the future time point. A historical corrosion reaction degree at the historical time point may be obtained by evaluation through a corrosion reaction model based on historical environmental data and historical pipeline corridor data at the historical time point. The corrosion reaction degree at the future time point may be evaluated by the corrosion reaction model based on environmental data and pipeline corridor data at the future time point. The reference corrosion rate is used to reflect a general corrosion rate of the pipeline corridor segment during a non ventilation intensity adjustment time period. The reference corrosion rate may be determined based on historical corrosion rate data. For example, all historical corrosion rate data during the non ventilation intensity adjustment time period under a month corresponding to the future time point in the historical data may be obtained, and the reference corrosion rate may be determined by calculating the average or mode. The historical corrosion rate data is calculated based on historical corrosion reaction degree data of the pipeline corridor segment obtained from evaluation by the corrosion reaction model.

More descriptions regarding the corrosion reaction model may be found in FIG. 3 and related descriptions thereof.

In some embodiments, the gas company management platform may correct the adjusted duration based on the corrosion change in the pipeline corridor segment by an empirical formula. For example, the corrected adjusted duration may be affected by the corrosion change, and the corrected adjusted duration may be expressed as follows: the corrected adjusted duration=adjusted duration*(1+corrosion change).

The corrosion change of the pipeline corridor segment may be determined based on the corrosion reaction degree of the pipeline corridor segment obtained from the evaluation by the corrosion reaction model at different time points, which may reduce impacts of the limitations of model evaluation or prediction on the reliability of evaluation results or prediction results, and reduce the calculation error of the corrosion change. Adjusting the adjusted duration based on the corrosion change may fully ensure the air quality inside the underground gas pipeline corridor, avoid the creation of an environment conducive to corrosion reaction, and improve the quality of the operation and maintenance of the pipeline corridor.

In some embodiments, the gas company management platform may correct the adjusted duration 450 based on the corrosion change 430 of the pipeline corridor segment and historical adjustment data 440 of the pipeline corridor segment.

The historical adjustment data is relevant historical data generated by the gas company management platform for adjusting the ventilation intensity of the pipeline corridor segment before the future time point. The historical adjustment data includes a total count of historical adjustments and an effective count of historical adjustments. The total count of historical adjustments refers to a total count of ventilation intensity adjustment events for the pipeline corridor segment. The gas company management platform may store the total count of historical adjustments. The effective count of historical adjustments refers to a count of effective ventilation intensity adjustment events for the pipeline corridor segment. For a ventilation intensity adjustment event, the gas equipment object platform may obtain a corrosion reaction degree of the corresponding pipeline corridor segment after a ventilation intensity adjustment, and a predicted corrosion degree of the corresponding pipeline corridor segment before the ventilation intensity adjustment. It is determined whether a difference between the corrosion reaction degree and the predicted corrosion degree is less than a preset threshold value by determining whether the ventilation intensity adjustment event is a valid ventilation intensity adjustment event. The preset threshold is a condition used to determine whether the corrosion reaction degree is effectively controlled. For example, the preset threshold may be a value set empirically.

In some embodiments, the corrected adjusted duration may be affected by the corrosion change and a correction factor. The corrected adjusted duration may be expressed as follows: corrected adjusted duration=adjusted duration*(1+corrosion change)*correction factor. The correction factor refers to a coefficient determined based on the historical adjustment data. The higher the count of valid historical adjustments, the smaller the correction factor. The correction factor may be expressed as follows: correction factor=preset factor−the count of valid historical adjustments/total count of historical adjustments. The preset factor is greater than 1 and may be set empirically.

Considering the historical adjustment data when correcting the adjusted duration improves the accuracy of the determined adjusted duration, which is conducive to further ensuring the air quality inside the underground gas pipeline corridor, avoiding the creation of the environment conducive to corrosion reaction, and improving operation and maintenance quality of the pipeline corridor.

Some embodiments of the present disclosure provide a non-transitory computer-readable storage medium storing computer instructions. When executing the computer instructions, a computer implements the method for supervising the safety ventilation of the underground gas pipeline corridor as described in any one of the embodiments of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for supervising safety ventilation of an underground gas pipeline corridor based on Internet of Things (IoT), wherein the method is executed by a gas company management platform of a system for supervising safety ventilation of the underground gas pipeline corridor based on IoT, and the method comprises:
obtaining environmental data of a pipeline corridor segment of the underground gas pipeline corridor from a gas equipment object platform via a gas company sensing network platform, and obtaining pipeline corridor data of the underground gas pipeline corridor from a government supervision comprehensive database via a smart gas government safety supervision sensing network platform, wherein the pipeline corridor data include at least one of ventilation data, structural data, and distribution sequence data;
determining a corrosion reaction degree of the pipeline corridor segment based on the environmental data and the pipeline corridor data; and
adjusting a ventilation intensity of the pipeline corridor segment in response to the corrosion reaction degree meeting a predetermined adjustment condition.

2. The method of claim 1, wherein the distribution sequence data includes distribution information of groundwater at a plurality of consecutive time points, and the determining a corrosion reaction degree of the pipeline corridor segment based on the environmental data and the pipeline corridor data includes:
predicting a predicted sequence set of the pipeline corridor segment in a future time period based on the environmental data and the pipeline corridor data; and
in response to the predicted sequence set meeting a predetermined warning condition, issuing a warning message.

3. The method of claim 2, wherein the predicting a predicted sequence set of the pipeline corridor segment in a future time period based on the environmental data and the pipeline corridor data includes:
predicting the predicted sequence set by a corrosion reaction model based on the environmental data, the pipeline corridor data, and a pipeline corrosion protection property, the corrosion reaction model being a machine learning model.

4. The method of claim 3, wherein the corrosion reaction model includes a data prognosis layer and an extent assessment layer, the environmental data includes prognostic environmental data, the predicting the predicted sequence set by a corrosion reaction model based on the environmental data, the pipeline corridor data, and a pipeline corrosion protection property includes:
determining prognostic data through the data prognosis layer based on a groundwater distribution map; and
predicting the predicted sequence set based on the prognostic data, the environmental data, the pipeline corridor data, and the pipeline corrosion protection property via the extent assessment layer.

5. The method of claim 2, further comprising:
determining an estimated time period for which a predicted corrosion degree of the pipeline corridor segment meets a predetermined corrosion condition; and
determining a subsequent maintenance program for the pipeline corridor segment based on the estimated time period, importance of the pipeline corridor segment, and historical maintenance data of the pipeline corridor segment.

6. The method of claim 5, wherein the estimated time period is determined based on the predicted sequence set and prognostic environmental data.

7. The method of claim 1, wherein the adjusting a ventilation intensity of the pipeline corridor segment in response to the corrosion reaction degree meeting a predetermined adjustment condition includes:
obtaining a maintenance effect of the pipeline corridor segment via the gas company sensing network platform via a gas company engineering maintenance object platform; and
determining an adjusted duration of the ventilation intensity based on an estimated time period and the maintenance effect.

8. The method of claim 7, further comprising:
correcting the adjusted duration based on a corrosion change in the pipeline corridor segment.

9. The method of claim 8, wherein the correcting the adjusted duration based on a corrosion change in the pipeline corridor segment includes:
correcting the adjusted duration based on the corrosion change and historical adjustment data for the pipeline corridor segment.

10. A system for supervising safety ventilation of an underground gas pipeline corridor based on Internet of Things (IoT), wherein the system includes a smart gas government safety supervision service platform, a smart gas government safety supervision management platform, a smart gas government safety supervision sensing network platform, a smart gas government safety supervision object platform, a gas company sensing network platform, and a gas equipment object platform, wherein
the smart gas government safety supervision service platform is configured to interact with the smart gas government safety supervision management platform;
the smart gas government safety supervision management platform includes a government supervision comprehensive database;
the smart gas government safety supervision object platform includes a gas company management platform; the smart gas government safety supervision sensing network platform is configured to interact with the smart gas government safety supervision management platform and the gas company management platform;
the gas company sensing network platform is configured to interact with the gas equipment object platform and the gas company management platform;
the gas company management platform is configured to:
obtain environmental data of a pipeline corridor segment of the underground gas pipeline corridor from the gas equipment object platform via the gas company sensing network platform, and obtain pipeline corridor data of the underground gas pipeline corridor from the government supervision comprehensive database via the smart gas government safety supervision sensing network platform, wherein the pipeline corridor data include at least one of ventilation data, structural data, and distribution sequence data;
determine a corrosion reaction degree of the pipeline corridor segment based on the environmental data and the pipeline corridor data, and transmit the corrosion reaction degree to the smart gas government safety supervision management platform via the smart gas government safety supervision sensing network platform; and
adjust a ventilation intensity of the pipeline corridor segment in response to the corrosion reaction degree meeting a predetermined adjustment condition, and transmit an instruction for adjusting the ventilation intensity to the gas equipment object platform via the gas company sensing network platform.

11. The system of claim 10, wherein the distribution sequence data includes distribution information of groundwater at a plurality of consecutive time points, and the gas company management platform is further configured to:
predict a predicted sequence set of the pipeline corridor segment in a future time period based on the environmental data and the pipeline corridor data; and
in response to the predicted sequence set meeting a predetermined warning condition, issue a warning message to the smart gas government safety supervision management platform via the smart gas government safety supervision sensing network platform.

12. The system of claim 11, wherein the gas company management platform is further configured to:
predict the predicted sequence set by a corrosion reaction model based on the environmental data, the pipeline corridor data, and a pipeline corrosion protection property, the corrosion reaction model being a machine learning model.

13. The system of claim 12, wherein the corrosion reaction model includes a data prognosis layer and an extent assessment layer, the environmental data includes prognostic environmental data, and the gas company management platform is further configured to:
determine prognostic data through the data prognosis layer based on a groundwater distribution map; and
predict the predicted sequence set based on the prognostic data, the environmental data, the pipeline corridor data, and the pipeline corrosion protection property via the extent assessment layer.

14. The system of claim 11, further comprising a gas company engineering maintenance object platform, wherein the gas company management platform is further configured to:
determine an estimated time period for which a predicted corrosion degree of the pipeline corridor segment meets a predetermined corrosion condition; and
determine a subsequent maintenance program for the pipeline corridor segment based on the estimated time period, importance of the pipeline corridor segment, and historical maintenance data for the pipeline corridor segment, and send the subsequent maintenance program via the gas company sensing network platform to the gas company engineering maintenance object platform.

15. The system of claim 14, wherein the estimated time period is determined based on the predicted sequence set and prognostic environmental data.

16. The system of claim 10, further comprising a gas company engineering maintenance object platform, wherein the gas company management platform is further configured to:
obtain a maintenance effect of the pipeline corridor segment via the gas company sensing network platform via the gas company engineering maintenance object platform; and
determine an adjusted duration of the ventilation intensity based on an estimated time period and the maintenance effect.

17. The system of claim 16, wherein the gas company management platform is further configured to:
correct the adjustment duration based on a corrosion change in the pipeline corridor segment.

18. The system of claim 17, wherein the gas company management platform is further configured to:
correct the adjustment duration based on the corrosion change and historical adjustment data for the pipeline corridor segment.

19. A non-transitory computer-readable storage medium storing computer instructions, wherein when reading the computer instructions in the storage medium, a computer implements the method of claim 1.
